(19) United States
(12) Patent Application Publication
(10) Pub. No.: US 2008/0044536 A1
(43) Pub. Date: Feb. 21, 2008

(54) Cooking rod

(76) Inventor: Aaron Barth, Carlisle, MA (US)

Correspondence Address: JOHN C. GORECKI, ESQ., P.O BOX 553, CARLISLE, MA, 01741, US

(21) Appl. No.: 11/726,815

(22) Filed: Mar. 23, 2007

Related U.S. Application Data
(63) Continuation-in-part of application No. 29/264,789, filed on Aug. 17, 2006, now Pat. No. D548003.

(51) Int. Cl. A47J 43/00; A23L 1/01

(52) U.S. Cl. 426/523; 99/427

(57) ABSTRACT

A cooking rod has a piercing rod and an end, that together are configured to conduct heat into a central area of a piece of meat. The piercing rod may be formed from aluminum or other highly conductive material and has a sharpened end to enable it to pierce the meat during the insertion process. The end has a body that connects to the piercing rod and a fan connected to the body and configured to extend to capture heat from the environment to be conveyed into the interior of the piece of meat. The fan may optionally include grooves to increase the thermal exchange area, which grooves may also be arranged in a decorative pattern. Optionally, the fan may extend through a layer of foil covering the piece of meat to enable the fan to come into contact with the hot air in the oven to further accelerate cooking of the meat.

### CROSS-REFERENCE TO RELATED APPLICATIONS

This application is a continuation in part of and claims priority to design Pat. application No. 29/264,789, filed Aug. 17, 2006 and entitled END FOR A COOKING ROD, the content of which is hereby incorporated herein by reference.

### BACKGROUND OF THE INVENTION

1. Field of the Invention

The present invention relates to cooking rods configured to accelerate the rate of cooking of a piece of meat such as a piece of poultry.

2. Description of the Related Art

Cooking rods may be used to convey heat from an oven or other external environment to an internal area of a piece of meat. For example, cooking rods may be hollow and enable hot air to reach an inner area of a roast, or may be solid and enable heat to be conveyed to the internal area through convection. Although several such rods are known, it still would be advantageous to provide a new cooking rod that may be used to accelerate the rate of cooking of a piece of meat such as a piece of poultry.

### SUMMARY OF THE INVENTION

A cooking rod has a piercing rod and an end, that together are configured to conduct heat into a central area of a piece of meat. The piercing rod may be formed from aluminum or other highly conductive material and has a sharpened end to enable it to pierce the meat during the insertion process. The end has a body that connects to the piercing rod and a fan connected to the body and configured to extend to capture heat from the environment to be conveyed into the interior of the piece of meat. The fan may optionally include grooves to increase the thermal exchange area, which grooves may also be arranged in a decorative pattern. Optionally, the fan may extend through a layer of foil covering the piece of meat to enable the fan to come into contact with the hot air in the oven to further accelerate cooking of the meat.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIGS. 1 and 2 are front perspective views of examples of cooking rods according to embodiments of the invention; and

FIG. 3 is a side view of the cooking rod in use according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, and dimensions, have not been described in detail so as not to obscure the invention.

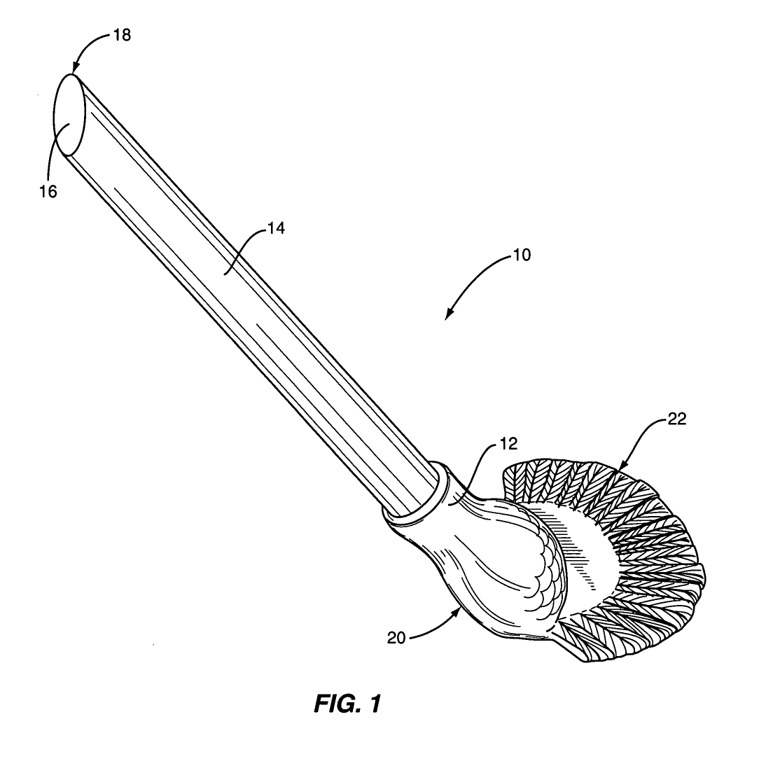

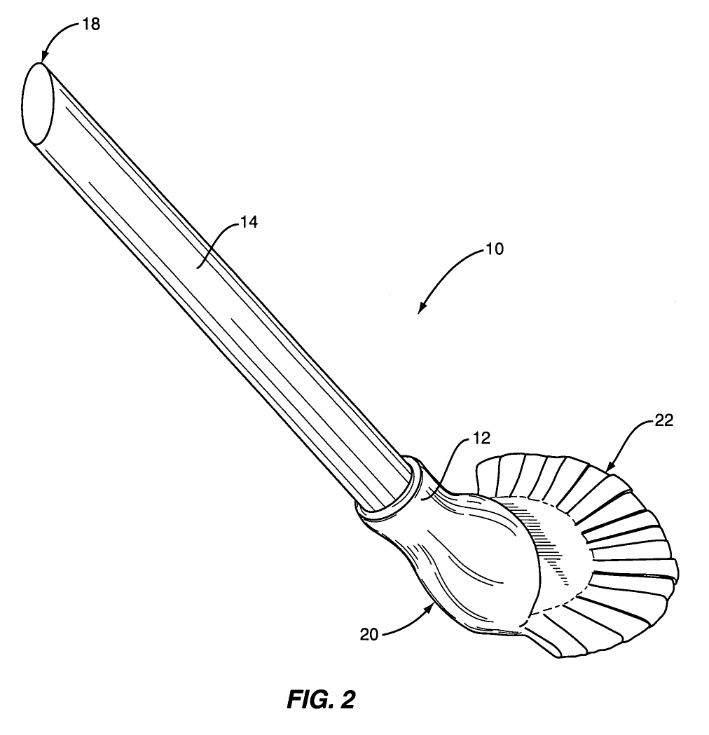

FIGS. 1 and 2 illustrate examples of a cooking rod according to embodiments of the invention. As shown in FIGS. 1 and 2, the cooking rod 10 includes an end 12 and a piercing rod 14 designed to skewer a piece of meat. The piercing rod in the embodiment shown in FIGS. 1 and 2 has a beveled face 16 causing the rod to have a sharp point 18 to enable the piercing rod to be pushed into the piece of meat more easily. Other types of points may be used as well, such as a conical pointed tip.

The piercing rod 14 may be made of a highly conductive material such as 1 inch (2.54 cm) or ¾ inch (1.8 cm) solid metal rod or another material with a high thermal conductivity. For example, the following table shows the thermal conductivity of several common materials that may be used to implement the piercing rod 14 and/or the end 12. Values in the table are in k (W/m K) at 25 degrees C., and were obtained from an Internet web site currently available at http://www.engineeringtoolbox.com/thermal-conductivity-d_{—}429.html. 1 W/(m.K)=1 W/(m°.C.)=0.85984 kcal/(h.m.° C.)=0.5779 Btu/(ft.h.° F.):

TABLE I
Thermal conductivity values of common materials

| Material | Thermal Conductivity |
|---|---|
| Aluminum | 250 |
| Gold | 310 |
| Copper | 400 |
| Silver | 429 |

Depending on the particular manner in which the materials are tested, the particular k values may change. Note, in this regard, that the k value of a material may be temperature dependent. Additionally, somewhat different k values are reported by different authorities and the invention is not limited to materials exhibiting these precise k values. Rather, these values are given as examples to show the relative conductivity of several common materials that may be used to create one or more of the components of the cooking rod.

All of these materials in the above table may be considered to have a high thermal conductivity. Although Aluminum is currently preferred as the preferred material for forming the piercing rod based on cost considerations, it may be appreciated that other materials with high thermal conductivity may be used as well. For example, alloys having a high thermal conductivity may be used as well. Likewise, commercially available materials may include impurities and the invention is not limited to an embodiment that uses pure aluminum, pure copper, etc., as the particular material selected for use in manufacturing the cooking rod may be a function of price as well as performance.

Additionally, one or more of the components of the cooking rod may be coated or otherwise treated to make the cooking rod more resistant to corrosion or otherwise to make it more suitable for cooking. For example, the rod and/or the end may be plated in chrome, nickel, or another metal, may be powder coated, anodized, porcelain glazed, Teflon™ coated, or encased in a metal such as stainless steel. For example, the rod may be formed from a solid aluminum rod that has been anodized, or may be formed from a copper core that has been encased in an outer stainless steel casing. In this second example, since stainless steel has a relatively low thermal conductivity (k=˜18) preferably the thickness of the stainless steel outer layer would be relatively thin to maximize the overall conductivity of the cooking rod.

FIGS. 1 and 2 show two different embodiments of the cooking rod, which differ in the way in which the end 12 is configured. Specifically, as shown in FIG. 1, the end 12 may include a plurality of grooves that form a decorative or other pattern on the end. FIG. 2 differs from FIG. 1 in that it has fewer grooves on the end. The grooves, in addition to forming a decorative pattern, also serve to increase the effective area of the end to increase the thermal transfer properties of the end.

The end 12 and the rod 14 may be formed form one piece of material for example by being drop forged or otherwise cast as a unified item. Alternatively, the end and the rod may be formed independently and then joined using a suitable process. For example, the end 12 may be formed to have a cavity carrying female threads and the rod 14 may be threaded as well so that the two pieces may be screwed together. Persons skilled in metal working will understand that many different ways of joining the two pieces may be utilized.

The rod 14 and the end 12 may be made of the same material, such as both pieces may be made from aluminum, or the two pieces may be made from different materials. For example, the rod 14 may be made of aluminum and the end may be made from copper. Other combinations of materials may be used as well. Optionally, the pieces may be made from alloys or may be made from layered materials in which, for example, the rod has an interior core formed from copper and an aluminum exterior, or the rod has an inner aluminum core and an outer copper cladding. Likewise, an inner copper or aluminum core may be clad in a stainless steel outer casing. Many different ways of implementing the rod and end may be determined by persons skilled in the art based on the teachings of this application and the invention is not limited to only those particular embodiments disclosed herein.

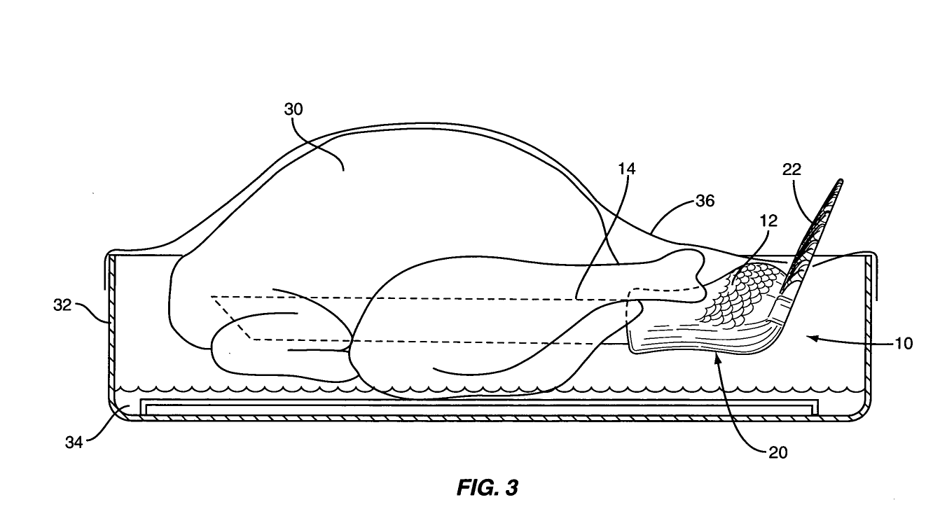

FIG. 3 shows an embodiment of the cooking rod in use. Although the example shown in FIG. 3 illustrates the cooking rod inserted into a turkey, the cooking rod is not limited to use in connection with cooking turkeys, as it may also be used in connection with other meats such as hams, pork roasts, chickens, beef roasts, and other commonly consumed large pieces of meat.

As shown in FIG. 3, the cooking rod 10 may be inserted into a piece of meat 30 and placed in a pan 32. The sharp point on the tip of the cooking rod enables the cooking rod to pierce the meat 30 so that the cooking rod is surrounded by the meat to cause good contact between the rod 14 and the meat 20. The end has a body 20 configured to connect to the rod 14 and an extending fan 22 designed to extend away from the meat to provide a large surface area to capture heat from the surrounding environment. For example, the fan may extend downward to contact the bottom of the pan and/or whatever juices 34 have accumulated in the bottom of the pan 32. Alternatively, as shown in FIG. 3, the fan may extend upward into the oven to be exposed to the heat of the oven. For example, where the turkey is covered with aluminum foil 36 during the roasting process, the fan may be pushed through a slit in the aluminum foil 36 to extend above the aluminum foil into the oven cavity. Exposing the fan to the hot air of the oven enables the cooking rod collect heat which may then be conveyed into the interior of the turkey. This allows the cooking time to be reduced to thereby conserve energy and also to increase the convenience associated with cooking the meat. Although the rod shown in FIG. 3 is illustrated as partially extending through the turkey, the rod may extend all the way through the turkey as well depending on the length of the rod and the size of the turkey. The rod may be placed through the cavity of the turkey if desired.

An example cooking rod was produced form a 1 inch diameter aluminum rod, and was used to cook a stuffed turkey. The cooking rod in this instance was formed from a solid aluminum rod but did not include the end 12 as that part had not been fabricated at the time the rod was used to cook the stuffed turkey. In the experiment, the cooking rod was inserted into a turkey so that approximately 4 inches of the cooking rod 14 extended from the turkey. The rod was then left in the turkey for the duration of the cooking process.

During the cooking process, the oven was preheated to 450°. The turkey was placed in a pan in a normal roasting position with the breast facing upwards. The rod was then inserted into the turkey and one cup of water was added to the bottom of the pan. The turkey was then covered in aluminum foil with the end of the rod extending through a small hole in the foil. About half way through cooking the temperature of the oven was turned down to 400° without opening the oven door. Close to the anticipated end of the baking period the aluminum foil was removed so that the turkey could be basted. Once the temperature indicator in the turkey popped, the turkey was removed and covered with a towel to enable its temperature to be maintained while it continued to cook.

The cooking time for roasting the turkey using this above described process was approximately 10-12 minutes per pound. Normal cooking time for a turkey is generally considered to be 20 minutes per pound, which indicates that the use of the cooking rod was able to accelerate cooking of the turkey by about 50%. Since the normal cooking temperature for a turkey is on the order of 325°-350°, use of the cooking rod also enabled the turkey to be cooked at a much higher temperature than normal as well, without causing the turkey to become excessively dry.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A cooking rod, comprising:
a rod designed to pierce a piece of meat; and
an end having a body and a fan extending away from the body, the end being connected to the rod at the body such that the fan extends away from an axis of the rod to enable the fan to collect heat from outside the piece of meat.

2. The cooking rod of claim 1, wherein the rod and the end are two separate pieces of material that are permanently joined together.

3. The cooking rod of claim 1, wherein the rod and the end are two separate pieces of material that are detachably joined together.

4. The cooking rod of claim 3, wherein the body has a female cavity defined therein carrying threads, and wherein the rod is threaded to screw into the female cavity.

5. The cooking rod of claim 1, wherein the rod and the body are formed from one piece of material.

6. The cooking rod of claim 1, wherein the rod is made of aluminum.

7. The cooking rod of claim 6, wherein the rod is cylindrical, a proximal end of the cylindrical rod being connected to the end, and a distal end of the cylindrical rod being designed to pierce the piece of meat.

8. The cooking rod of claim 7, wherein the distal end is beveled.

9. The cooking rod of claim 7, wherein the distal end is pointed.

10. The cooking rod of claim 1, wherein the rod is solid.

11. The cooking rod of claim 10, wherein the rod is formed from a 1 inch solid aluminum bar.

12. The cooking rod of claim 10, wherein the end is solid.

13. A method of cooking a piece of meat, comprising:
piercing the piece of meat with a cooking rod, the cooking rod having an extension that extends out of the piece of meat;
placing the piece of meat in a pan;
covering the pan with aluminum foil to encase the piece of meat;
placing the pan into an oven cavity;
wherein the extension extends through the aluminum foil into an interior of the oven cavity to capture heat from the oven cavity and convey the heat into the piece of meat.

14. The method of claim 13, wherein the extension is an end having a body and a fan.

15. The method of claim 13, further comprising turning on the oven to a temperature in excess of 400 degrees for a majority of a cooking time.
